(19) United States
(12) Patent Application Publication
(10) Pub. No.: US 2026/0288754 A1
(43) Pub. Date: Sep. 24, 2026

(54) LONG-TERM CLOUD ARCHIVAL OPTIMIZATION FOR STREAMING MEDIA CONTENT

(71) Applicant: Charter Communications Operating, LLC, St. Louis, MO (US)

(72) Inventors: Leonardo Lizcano, Littleton, CO (US); Jay Shah, Parker, CO (US); Erdogan Simsek, Englewood, CO (US); Vipul Patel, Parker, CO (US)

(21) Appl. No.: 19/087,994

(22) Filed: Mar. 24, 2025

(51) Int. Cl. G06F 16/27

(52) U.S. Cl. CPC G06F 16/27

(57) ABSTRACT

A content item is stored to a first storage repository for a user of a content service. The content item comprises content metadata descriptive of content attributes of the content item. An item retrieval probability for the content item is determined based on the content attributes of the content item and historical user retrieval information. A migration threshold value is computed for the content item based on the item retrieval probability, a first storage cost associated with storage of the content item at the first storage repository, and a second storage cost associated with storage of the content item at a second storage repository. The migration threshold value is indicative of a future time T1 at which to migrate the content item. Responsive to occurrence of the future time T1, the content item is migrated from the first storage repository to the second storage repository.

### BACKGROUND

Cloud storage services are used by most organizations for data storage and retrieval. Cloud storage services generally implement multi-tiered services in which different classes of storage are provided to accommodate varying data access requirements. Storage classes can differ in factors such as retrieval speed, data retention policies, data retrieval costs, etc. For example, one service offered by a cloud storage service provider may provide high-speed retrieval, while offering another service that provides lower-speed retrieval for lower costs.

### SUMMARY

A content item is stored to a first storage repository for a user of a content service. Based on an item retrieval probability for the content item, a migration threshold value can be computed that is indicative of a future time T1 at which to migrate the content item. Responsive to occurrence of the future time T1, the content item is migrated from the first storage repository to the second storage repository.

In one implementation, a method is provided. The method includes storing, by a computing system comprising one or more processor devices, a content item to a first storage repository for a user of a content service associated with the first storage repository, wherein the content item comprises content metadata descriptive of one or more content attributes of the content item. The method further includes determining, by the computing system, an item retrieval probability for the content item based on the one or more content attributes of the content item and historical user retrieval information. The method further includes computing, by the computing system, a migration threshold value for the content item based on the item retrieval probability, a first storage cost associated with storage of the content item at the first storage repository, and a second storage cost associated with storage of the content item at a second storage repository, wherein the migration threshold value is indicative of a future time T1 at which to migrate the content item. The method further includes, responsive to occurrence of the future time T1, migrating, by the computing system, at least a portion of the content item from the first storage repository to the second storage repository.

In another implementation, a computing system is provided. The computing device includes a memory, and one or more processor device(s) coupled to the memory. The processor device(s) are to store a content item to a first storage repository for a user of a content service associated with the first storage repository, wherein the content item comprises content metadata descriptive of one or more content attributes of the content item. The processor device(s) are further to determine an item retrieval probability for the content item based on the one or more content attributes of the content item and historical user retrieval information. The processor device(s) are further to compute a migration threshold value for the content item based on the item retrieval probability, a first storage cost associated with storage of the content item at the first storage repository, and a second storage cost associated with storage of the content item at a second storage repository, wherein the migration threshold value is indicative of a future time T1 at which to migrate the content item. The processor device(s) are further to, responsive to occurrence of the future time T1, migrate at least a portion of the content item from the first storage repository to the second storage repository.

In another implementation, a non-transitory computer-readable storage medium is provided. The non-transitory computer-readable storage medium includes executable instructions to cause one or more processor device(s) to store a content item to a first storage repository for a user of a content service associated with the first storage repository, wherein the content item comprises content metadata descriptive of one or more content attributes of the content item. The instructions further cause the one or more processor device(s) to determine an item retrieval probability for the content item based on the one or more content attributes of the content item and historical user retrieval information. The instructions further cause the one or more processor device(s) to compute a migration threshold value for the content item based on the item retrieval probability, a first storage cost associated with storage of the content item at the first storage repository, and a second storage cost associated with storage of the content item at a second storage repository, wherein the migration threshold value is indicative of a future time T1 at which to migrate the content item. The instructions further cause the one or more processor device(s) to responsive to occurrence of the future time T1, migrate at least a portion of the content item from the first storage repository to the second storage repository.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1A is a block diagram of a computing environment at a first time TO suitable for implementing long-term cloud archival optimization for streaming media content according to some implementations of the present disclosure.

FIG. 1B is a block diagram of the computing environment at a time T1 suitable for implementing long-term cloud archival optimization for streaming media content according to some implementations of the present disclosure.

FIG. 1C is a block diagram of the computing environment at a time T2 suitable for implementing long-term cloud archival optimization for streaming media content according to some implementations of the present disclosure.

FIG. 2 is a communication flow diagram for long-term cloud archival optimization for streaming media content according to some implementations of the present disclosure.

FIG. 3 depicts a flow chart diagram of an example method for long-term cloud archival optimization for streaming media content according to some implementations of the present disclosure.

FIG. 4 is a block diagram of the computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Cloud storage services are used by most organizations for data storage and retrieval. Cloud storage services generally implement multi-tiered services in which different classes of storage are provided to accommodate varying data access requirements. Storage classes can differ in factors such as retrieval speed, data retention policies, data retrieval costs, etc. For example, one service offered by a cloud storage service provider may provide high-speed retrieval, while offering another service that provides lower-speed retrieval for lower costs.

As a specific example, cloud storage providers such as Amazon® Web Services (AWS) provide multiple types of storage repositories (i.e., services). One example is AWS S3® storage repositories, which provides high-speed data retrieval in exchange for a relatively high storage cost and a relatively low retrieval cost. Another example is AWS S3 Glacier® storage repositories, which provide high-speed data retrieval in exchange for a relatively low data storage cost and a relatively high data retrieval cost. Given the different costs associated with various storage repositories, the anticipated use-case for data (e.g., whether the data will be retrieved often, etc.) is an important factor to consider when selecting a particular storage repository.

In modern system architectures, it is common for cloud storage repositories to be employed alongside “on-premises” storage repositories. As described herein, a “cloud” storage repository refers to a cloud storage repository provided by a third-party cloud storage provider. An on-premises storage repository refers to physical or virtualized storage resources that belong to a particular organization. For example, a technology company may physically implement on-premises storage repositories from their company headquarters, while also subscribing to cloud storage repositories from a third-party cloud storage provider.

An example use-case of this hybrid architecture is for content services (e.g., cable television services, streaming services, internet television services, etc.). Content services often provide “content-on-demand” services, such as Video-on-demand or cloud Digital Video Recorder (cDVR) services. These services function by storing digital media content items (e.g., movies, television shows, recordings, video games, etc.) for users. In particular, a cDVR service can record a content item for a user and store the content item to a storage repository for “on-demand” retrieval by the user. In a hybrid architecture, the content service may first store the content item in an on-premises repository. On-premises repositories are generally designed to provide high-speed data retrieval, so that users can quickly access requested content items with minimal latency. Alternatively, content services may instead use an analogous cloud storage repository that offers high-speed data retrieval.

Storage repositories that offer high-speed data retrieval (e.g., on-premises repositories, certain cloud repositories, etc.) generally have high storage costs (e.g., a computational resource cost per unit of time, a monetary cost per unit of time, etc.). Content services generally wish to migrate content items from high-cost storage repositories to low-cost storage repositories to save resources. However, low-cost storage repositories exhibit various inefficiencies. For example, some low-cost storage repositories provide relatively low data retrieval speeds. When a content item is retrieved for a user, these lower speeds can introduce an element of latency that is disruptive to users. For another example, other low-cost storage repositories offer high data retrieval speeds with high data retrieval costs. When a content item is retrieved from the repository, the content service will incur a high storage cost for the retrieval. Without the capacity to determine an optimal threshold for migrating a content item, many content services cannot benefit from the advantages provided by content item migration.

Accordingly, implementations described herein propose long-term cloud archival optimization for streaming media content. More specifically, a computing system associated with a content service can store a content item to a first storage repository (e.g., a repository with high-speed data retrieval and high storage costs). For example, the computing system may store the content item based on a request from a user of the content service. The content item stored to the first storage repository can include content metadata. The content metadata can describe various content attribute(s) of the content item (e.g., a content type, a playback length, an associated genre, a seasonality of the content item, aggregated user feedback, etc.).

It should be noted that, as described herein, a “storage cost” includes both the cost to store the content item to the repository (e.g., monetary costs, computational resource costs, etc.), and the cost to retrieve the content item (e.g., monetary costs, computational resource costs, etc.). For example, if a data item is frequently retrieved from a storage repository with low costs for data storage and high costs for data retrieval, the “storage cost” for the repository may be higher than the “storage cost” for a different storage repository with high costs for data storage and low costs (or none) for data retrieval.

The computing system can compute an item retrieval probability for the content item based on the content attribute(s) of the content item and historical user retrieval information. The item retrieval probability can represent a probability that the user will retrieve a stored content item over time. As passes since a content item was first stored, it becomes less likely that a content item will be retrieved by a user. However, the rate at which this probability decreases can vary based on the content type of the content item (e.g., whether the content item is audiovisual content, a videogame, a live sports event recording, video-on-demand, etc.).

The rate at which the retrieval likelihood decreases for each type of content can be represented by decay functions, and can be determined based on aggregate user retrieval metrics. Specifically, in some implementations, the historical user retrieval information can include decay functions associated with various types of content items (e.g., a decay function for live sports games, a decay function for video games, etc.). The computing system can determine the item retrieval probability for the content item by selecting the decay function based on the content type of the content item.

The computing system can determine a migration threshold value for the content item. The migration threshold value can represent an optimal time at which to migrate the content item from the first storage repository to the second storage repository. The migration threshold value can be based on the item retrieval probability, a storage cost associated with the first storage repository, and a storage cost associated with the second storage repository.

For example, the storage cost for the first storage repository can be based on a high data storage cost (i.e., cost to store data per unit of time) and a low retrieval cost. The storage cost for the second storage repository can be based on a low data storage cost and a high data retrieval cost. As such, the cost associated with the second storage repository can be based on the probability that the user actually retrieves the content item before it expires. The computing system can determine the migration threshold value by determining a time at which the cost associated with the first storage repository is equal to the data storage cost of the second storage repository and the retrieval cost times the item retrieval probability.

At the time indicated by the migration threshold value, the computing system can migrate the content item from the first storage repository. In such fashion, implementations described herein can facilitate benefits provided by migrating content items to low-cost storage repositories while minimizing the costs associated with content item retrieval from low-cost storage repositories.

Aspects of the present disclosure provide a number of technical effects and benefits. As one example technical effect and benefit, as described above, implementations described herein can enable content services (and/or other services) to utilize content item migration to substantially reduce costs and/or resource utilization while minimizing disruptions and additional costs associated with content item retrieval from low-cost storage repositories.

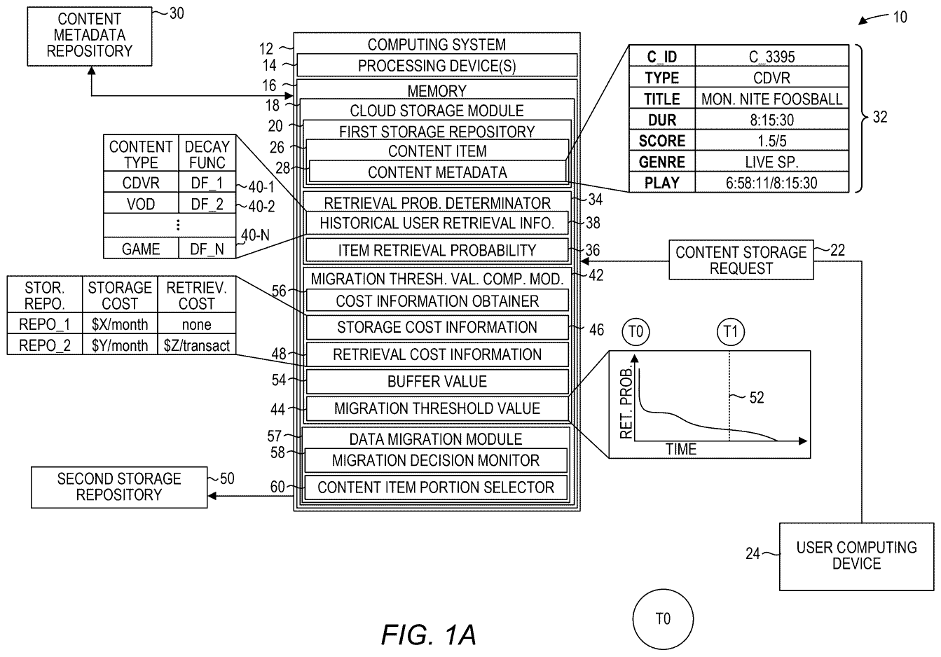

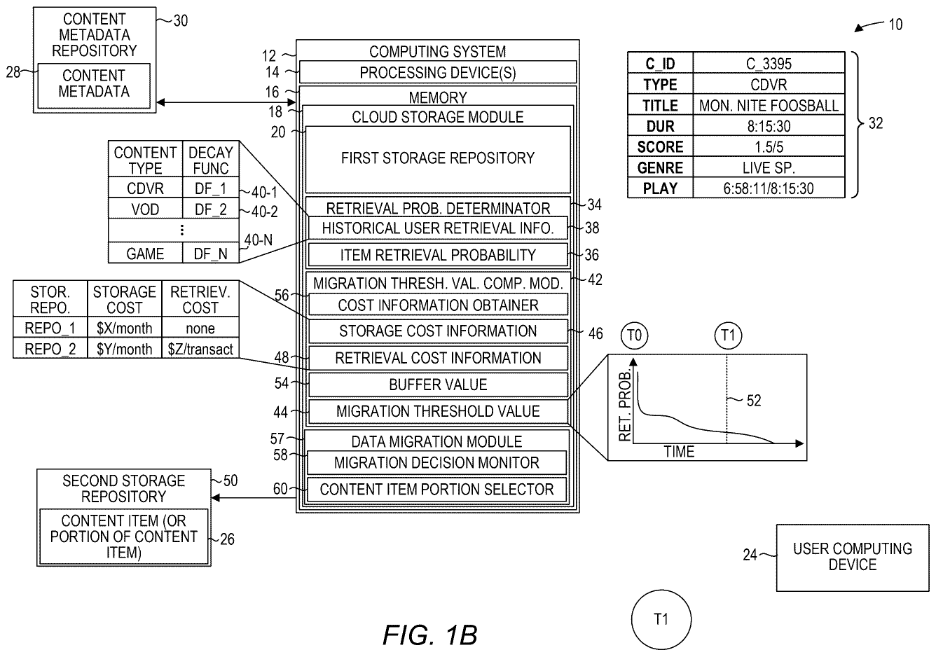

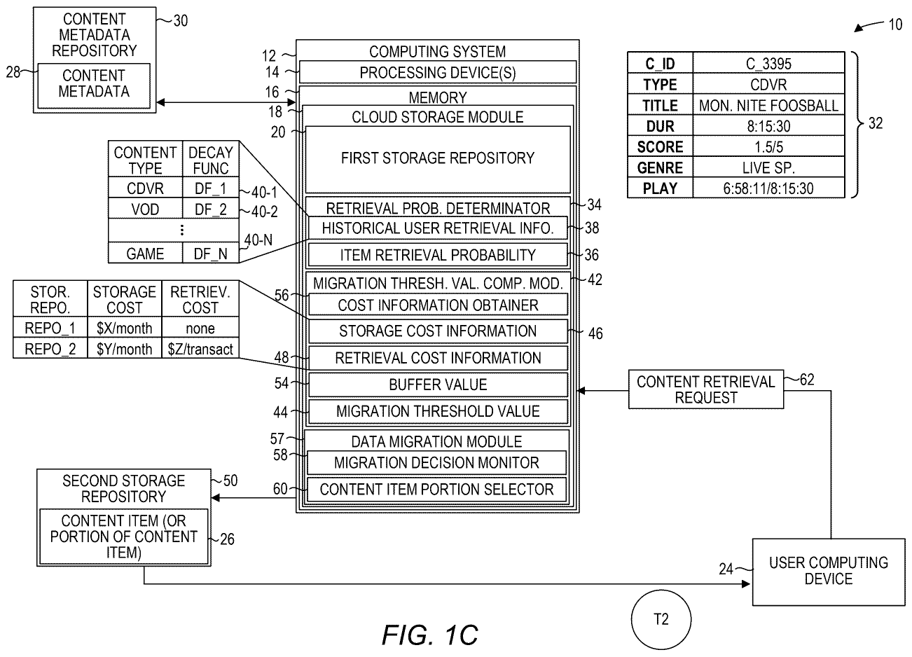

FIG. 1A is a block diagram of a computing environment 10 at a first time TO suitable for implementing long-term cloud archival optimization for streaming media content according to some implementations of the present disclosure. A computing environment 10 can include a computing system 12 with one or more processor device(s) 14 and a memory 16. As described herein, the “computing environment” 10 can be any type or manner of computing environment (e.g., a collection of computing devices, systems, and related infrastructure associated with a particular entity or organization), such as a “confidential” computing environment in which sensitive data and code is protected during processing, a “public” computing environment, etc. For example, the computing environment 10 can be or otherwise include a confidential computing “enclave” that leverages hardware-based execution environments and secure virtualization technologies, such as memory encryption, to isolate critical computations and prevent unauthorized access to data while in use. For another example, the computing environment 10 can be a distributed computing environment that utilizes computing resources across a variety of different types of devices (e.g., servers, virtualized devices, user devices, Internet-of-Things (IoT) devices, etc.).

Additionally, or alternatively, in some implementations, the computing environment 10 can be a cloud computing environment implemented using the computing system 12. For example, the computing system 12 can implement a cloud computing platform by implementing a variety of cloud modules to provide cloud functionality. The cloud computing platform implemented by the computing system 12 can be utilized by various users, entities, organizations, devices, etc. within (and/or external to) the computing environment 10.

Specifically, in some implementations, the computing environment 10 can be a computing environment associated with a content service. As described herein, a content service is any type of service that provides access to content items (e.g., cDVR recordings, video games, Augmented Reality (AR)/Virtual Reality (VR) content, video on demand, etc.). The computing environment 10 can include any type of computing resources or software resources necessary for distributing content items, such as content distribution networks (CDNs), storage repositories, network infrastructure, etc.

In some implementations, the computing system 12 may be a computing device that includes multiple computing devices (i.e., a computing system). Alternatively, in some implementations, the computing system 12 may be one or more computing devices within a computing system that includes multiple computing devices. Similarly, the processor device(s) 14 may include any computing or electronic device capable of executing software instructions to implement the functionality described herein.

The memory 16 can be or otherwise include any device(s) capable of storing data, including, but not limited to, volatile memory (random access memory, etc.), non-volatile memory, storage device(s) (e.g., hard drive(s), solid state drive(s), etc.). In some implementations, the memory 16 can include a containerized unit of software instructions (i.e., a “packaged container”). The containerized unit of software instructions can collectively form a container that has been packaged using any type or manner of containerization technique.

A containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

In particular, the memory 16 can include one or more storage repositories. As described herein, a “storage repository” refers to either an “on-premises” storage repository (e.g., a repository implemented at one or more physical locations associated with a content service) or a cloud-based storage repository (e.g., a repository implemented via a mix of physical and virtualized resources, generally in a distributed fashion). A cloud-based storage repository can refer to either a first-party cloud storage repository or a third-party cloud storage repository (e.g., a cloud storage repository implemented by a cloud storage provider). As such, in some instances, the physical resources of an on-premises storage repository may implement a first-party cloud storage repository.

In some implementations, the computing environment 10 can include multiple types of nodes. As described herein, a “node” generally refers to a discrete unit of hardware and/or software resources. In some instances, nodes within the computing environment 10 can be configured to perform specific tasks. For example, some nodes within the computing environment 10 can be configured as “compute” or “processing” nodes that handle processing tasks or provide processing-heavy services. Compute nodes are generally allocated with hardware devices that can facilitate processing tasks, such as Graphics Processing Units (GPUs), Central Processing Units (CPUs), Application-specific Integrated Circuits (ASICs), Field-Programmable Gate Arrays (FPGAs), etc.

Conversely, storage nodes can be allocated with hardware devices to facilitate storage tasks, such as storage devices (e.g., hard drives, etc.), memory, high-bandwidth network devices, physical storage media, etc.). It should be noted that in some instances, storage nodes can include processing devices (e.g., CPUs, etc.) to facilitate storage operations (e.g., read/write operations) and processing nodes can include storage devices (e.g., random access memory) to facilitate processing operations.

The memory 16 can include a cloud storage module 18. The cloud storage module 18 can handle storage and retrieval of content items. To do so, the cloud storage module 18 can be operable to interface with first-party storage repositories and/or third-party storage repositories. Specifically, the cloud storage module 18 can include a first storage repository 20. Although the first storage repository 20 is illustrated as being included in the cloud storage module 18, in some implementations, the first storage repository 20 can be a third-party storage repository accessed by the cloud storage module 18 via an Application Programming Interface (API). The first storage repository 20 can be a storage repository with high-speed data retrieval and high storage costs, such as an on-premises storage repository or an Amazon S3® storage repository.

At the first time TO (e.g., a particular time, a particular period of time, etc.), the cloud storage module 18 can receive a content storage request 22 from a user computing device 24. The user computing device 24 (e.g., a smartphone, laptop, wearable device, AR/VR device, etc.) can be associated with a user of the content service. The content storage request 22 can request that a particular content item 26 be stored. In response to the content storage request 22, the computing system 12 can store the content item 26 to the first cloud storage repository. In this manner, the content item 26 can be subsequently retrieved for the user and transmitted to the user computing device 24 with minimal latency due to the high data retrieval speed provided by the first storage repository 20.

The content item 26 can include content metadata 28. In some implementations, the content metadata 28 can be obtained alongside the content item 26 (and/or can be included in the content item 26). Alternatively, in some implementations, the content metadata 28 can be obtained from a content metadata repository 30. If the content metadata 28 is included in the content item 26, the cloud storage module 18 can copy the content metadata 28 and transmit a copy of the content metadata 28 to the content metadata repository 30.

The content metadata 28 can describe content attributes 32 of the content item. In some implementations, the content attributes 32 can include a content type of the content item. In some implementations, the content type of a content type can refer to a “data type” of the content element (e.g., audiovisual content, AR/VR content, videogame content, cDVR content, etc.). Additionally, or alternatively, in some implementations, the content type for a content item can refer to the subject matter or format of the content. For example, one content item may be a cDVR live sports content type, while another content item may be a cDVR news program content type.

In some implementations, the content attributes 32 can include a playback length for the content item (e.g., an amount of time required to play the content item). Additionally, or alternatively, in some implementations, the content attributes 32 can include a genre associated with the content item (e.g., action, science fiction, fantasy, live sports, newscasts, etc.). Additionally, or alternatively, in some implementations, the content attributes 32 can include aggregated user feedback for the content item (e.g., aggregated scores from a review site, aggregated critic scores, etc.). In some implementations, the content attributes 32 can include a current playback statistic for the content item. For example, the content attributes 32 may indicate whether the content item has been viewed or retrieved previously by the user. For another example, the content attributes 32 may include a “bookmark” for a time at which the user last viewed the content item. The content attributes 32 may also identify one or more customer segments associated with the content item, such as, by way of non-limiting example, a gender, an age, a category, or the like.

The cloud storage module 18 can include a retrieval probability determinator 34. The retrieval probability determinator 34 can determine an item retrieval probability 36 for the content item 26. As described herein, an “item retrieval probability” refers to a probability that the user will retrieve the content item 26 over a period of time. In some implementations, the item retrieval probability 36 can be a decay function that represents the probability that the user will retrieve the content item 26 over time. In such instances, the item retrieval probability 36 can be used to determine a specific probability that the user will retrieve the content item 26 at a specific time.

In some implementations, the retrieval probability determinator 34 can include historical user retrieval information 38. The historical user retrieval information 38 can include decay functions 40-1-40-N (generally, decay functions 40). The retrieval probability determinator 34 can select one of the decay functions 40 to be (or represent) the item retrieval probability 36. Each of the decay functions 40 can represent a decrease over time in the probability that a user retrieves the content item 26. The decay functions 40 can include a decay function for each of the content types described by the content attributes 32. For example, the decay function 40-1 can be a decay function representing a decreasing probability that a user retrieves a CDVR content item, while the decay function 40-N can be a decay function representing a different decreasing probability that a user retrieves a videogame content item. The decay functions 40 can include linear and/or nonlinear decay functions.

In some implementations, the historical user retrieval information 38 can describe a user demographic classification (or multiple demographic classifications) associated with the user. A user demographic classification can refer to a discrete set of users associated with preferences for particular genres of content, types of content, formats of content, etc. For example, the user demographic classification may refer to a certain age range (e.g., 40-50 year olds), who generally demonstrate a preference for reality television. For another example, the user demographic classification may refer to enthusiasts of a particular genre (e.g., fantasy lovers, Sci-fi lovers, etc.). For yet another example, the user demographic classification may refer to a degree of educational attainment (e.g., PhD holders demonstrate a preference for documentaries), a geographic location (e.g., users living in the sun belt demonstrate a preference for movies with tropical locations, etc.), etc.

The cloud storage module 18 can include a migration threshold value computation module 42. The migration threshold value computation module 42 can compute a migration threshold value 44 for the content item 26. The migration threshold value 44 can indicate a future time T1 at which to migrate the content item 26. The migration threshold value 44 can be computed based on storage cost information 46 and retrieval cost information 48. The storage cost information 46 can describe a storage cost for storing data in the first storage repository 20 and a storage cost for storing data in a second storage repository 50.

The storage cost information 46 can describe a cost associated with storing data to the first storage repository 20 and the second storage repository 50 per a unit of time (e.g., per day, per month, per hour, etc.). To follow the depicted example, the first storage repository 20 can cost X per mon1th to store a certain quantity of data (e.g., 5 GB, 50 GB, etc.), while the second storage repository can cost Y per month to store the same quantity of data. In some implementations, the storage cost described by the storage cost information 46 can refer to a monetary cost charged by the cloud storage provider associated with the cloud storage repository. Additionally, or alternatively, in some implementations, the storage costs can refer to computational costs associated with storage of the resources (e.g., a “cost” assigned to utilization of storage resources, an amount of bandwidth required to store data, etc.).

Similarly, the retrieval cost information 48 can describe a cost associated with retrieving data from the first storage repository 20 and the second storage repository 50 per unit of data (e.g., per content item, per quantity of data (e.g., per 50 GB), etc.). To follow the depicted example, the first storage repository 20 can have no retrieval cost (or an insignificant retrieval cost), while the second storage repository can have a retrieval cost of Z per month. In some implementations, the retrieval cost described by the storage cost information 46 can refer to a monetary cost charged by the cloud storage provider associated with the cloud storage repository. Additionally, or alternatively, in some implementations, the retrieval costs can refer to computational costs associated with retrieval of the resources (e.g., a “cost” assigned to utilization of processing resources, an amount of bandwidth required to retrieve the data, etc.).

The migration threshold value computation module 42 can compute the migration threshold value 44 by identifying a future time T1 52 at which the storage costs for the first storage repository 20 is equal to the storage costs of the second storge repository in addition to the retrieval cost for the second storage repository 50 conditioned on the likelihood at the user will retrieve the content item 26. For example, the migration threshold value 44 may be computed to be a time at which:

$$SCfirstrepo = SCsecrepo + P ( t ) * RCsecrepo + bufferval$$

Where SCfirstrepo represents the storage cost for storing data at the first storage repository 20, SCsecrepo represents the storage cost for storing data at the second storage repository 50, RCsecrepo represents the retrieval cost for retrieving data from the second storage repository 50, P (t) represents the item retrieval probability 36 at a specific time, and bufferval represents an adjustable buffer value 54.

Because the item retrieval probability 36 represents the probability that the content item will be retrieved over time, the item retrieval probability 36 can be utilized to determine the probability that the content item will be retrieved at multiple specific times. In this manner, the item retrieval probability can be iteratively evaluated based on the above computation to identify the future time T1 at which to migrate the content item 26 (e.g., the time described by the migration threshold value 44).

The adjustable buffer value 54 can be an adjustable value that is adjusted based on at which content items are retrieved from the second storage repository 50. For example, if content items are retrieved at a higher rate from the second storage repository 50 than is desired (e.g., and therefore incurring higher than desired costs), the adjustable buffer value 54 can be adjusted so that a lower item retrieval probability 36 is needed to balance the above equation.

The migration threshold value computation module 42 can include a cost information obtainer 56. The cost information obtainer 56 can obtain the storage cost information 46 and the retrieval cost information 48. In some implementations, the cost information obtainer 56 can obtain the cost information via an API associated with a cloud storage provider. Additionally, or alternatively, in some implementations, the cost information obtainer 56 can obtain the cost information by determining the cost information based on current resource utilization. For example, assume that the first storage repository 20 is an on-premises storage repository belonging to the content service. Because the first storage repository 20 belongs to the content service, the costs associated with storing data to the first storage repository 20 may be a scalar value that represents current resource utilization in the first storage repository. If resource utilization is low, the corresponding “cost” may be low as there is no urgent need to reduce existing resource utilization. Conversely, if resource utilization is high (e.g., much of the storage repository is in use), the corresponding cost value can be higher.

The above implementations are described in the context of the second storage repository 50 having high storage retrieval costs with high data retrieval speeds. However, in some other implementations, the second storage repository 50 may be a repository with low data retrieval speeds and low data retrieval costs. In such instances, the “cost” associated with data retrieval is associated with the latency introduced by the low data retrieval speeds which causes disruptions for the user. This “cost” can be represented by a static cost value.

The migration threshold value computation module 42 can include a data migration module 57. The data migration module 57 can handle migration decisions and migration of data from the first storage repository 20 to the second storage repository 50. To do so, the data migration module 57 can include a migration decision monitor 58. The migration decision monitor 58 can track an amount of time that has passed since the content item 26 was last retrieved by the user (or stored for the user). The migration decision monitor 58 can also monitor a current time to determine if the future time T1 52 indicated by the mitigation threshold value 44 has been reached. Specifically, in some implementations, the migration decision monitor 58 can iteratively evaluate item retrieval probability 36 at a current time until the equation described previously reaches equilibrium.

For example, at the current time T0, the migration decision monitor 58 can determine that the item retrieval probability 36 multiplied by the retrieval cost for the second storage repository 50 in addition to the storage cost for the second storage repository 50 is greater than the storage cost associated with the first storage repository 20.

In some implementations, the data migration module 57 can include a content item portion selector 60. The content item portion selector 60 can select portions of the content item 26 for migration. In some implementations, the content item portion selector 60 can iteratively migrate portions of the content item over time. By migrating portions of the content item 26, the data migration module 57 can reduce the detrimental effects associated with retrieval of data from the second storage repository 50.

For example, assume that the data migration module 57 migrates a portion of the content item 26 to the first storage repository 20. Further assume that the second storage repository 50 provides low data retrieval speeds. When the user requests that the content item 26 be retrieved, the data migration module 57 can immediately transmit the portion of the content item remaining in the first storage repository 20 to the user computing device 24 while the data migration module 57 retrieves the other portion from the second storage repository 50. In this manner, by retaining a portion the content item 26 in the first storage repository 20, the data migration module 57 can mitigate the increase in latency caused by retrieval of the content item from the second storage repository 50.

Turning to FIG. 1B, FIG. 1B is a block diagram of the computing environment 10 at a time T1 suitable for implementing long-term cloud archival optimization for streaming media content according to some implementations of the present disclosure. At the time T1 52, the data migration module 57 can migrate the content item 26 from the first storage repository 20 to the second storage repository 50.

More specifically, at the time T1 52, the migration decision monitor can determine that the item retrieval probability 36 multiplied by the retrieval cost for the second storage repository 50 in addition to the storage cost for the second storage repository 50 is less than (or equal to) than the storage cost associated with the first storage repository 20. At that time, the data migration module 57 can migrate the content item 26 (or a portion thereof) to the second storage repository 50.

Turning to FIG. 1C, FIG. 1C is a block diagram of the computing environment 10 at a time T2 suitable for implementing long-term cloud archival optimization for streaming media content according to some implementations of the present disclosure. At the time T2, the computing system 12 can receive a content retrieval request 62 from the user computing device 24. In response, the computing system can retrieve the content item 26 from the second cloud storage repository and transmit the content item 26 to the user computing device 24.

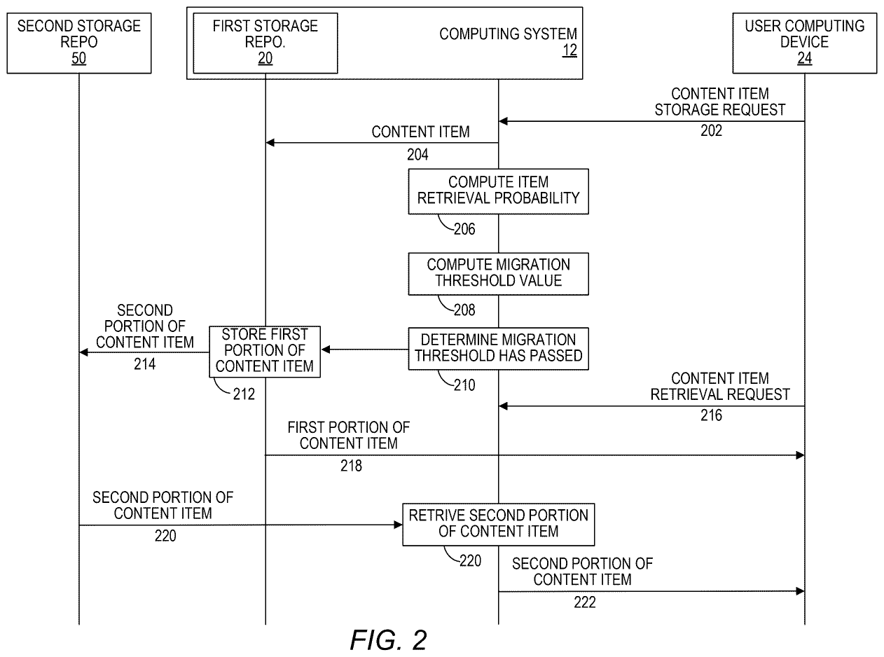

FIG. 2 is a communication flow diagram for long-term cloud archival optimization for streaming media content according to some implementations of the present disclosure. FIG. 2 will be discussed in conjunction with FIGS. 1A-1C.

Specifically, at 202, the computing system 12 can receive the content storage request 22 from the user computing device 24. At 204, the computing system 12 can store the content item 26 in the first storage repository 20. At 206, the computing system can compute the item retrieval probability 36.

At 208, the computing system can compute the migration threshold value 44.

At 210, the computing system 12 can determine whether the future time T1 indicated by migration threshold value 44 has occurred. At 212, If the future time T1 has occurred, the computing system 1 can store (or retain) a first portion of the content item 26 in the first storage repository, and at 214, migrate a second portion of the content item 26 to the second storage repository 50.

At 216, the computing system 12 can receive the content retrieval request 62 from the user computing device 24. In response, at 218, the computing system 12 can immediately serve the first portion of the content item 26 to the user computing device 24. Because the first portion of the content item 26 is stored to the first storage repository 20, latency introduced by low data retrieval speed is mitigated, therefore ensuring that the user is not disrupted.

At 220, concurrently with (or subsequent to) the computing system 12 serving the first portion of the content item 26, the computing system can retrieve the second portion of the content item 26 from the second storage repository 50. At 222, the computing system 12 can transmit the second portion of the content item 222 to the user computing device 24.

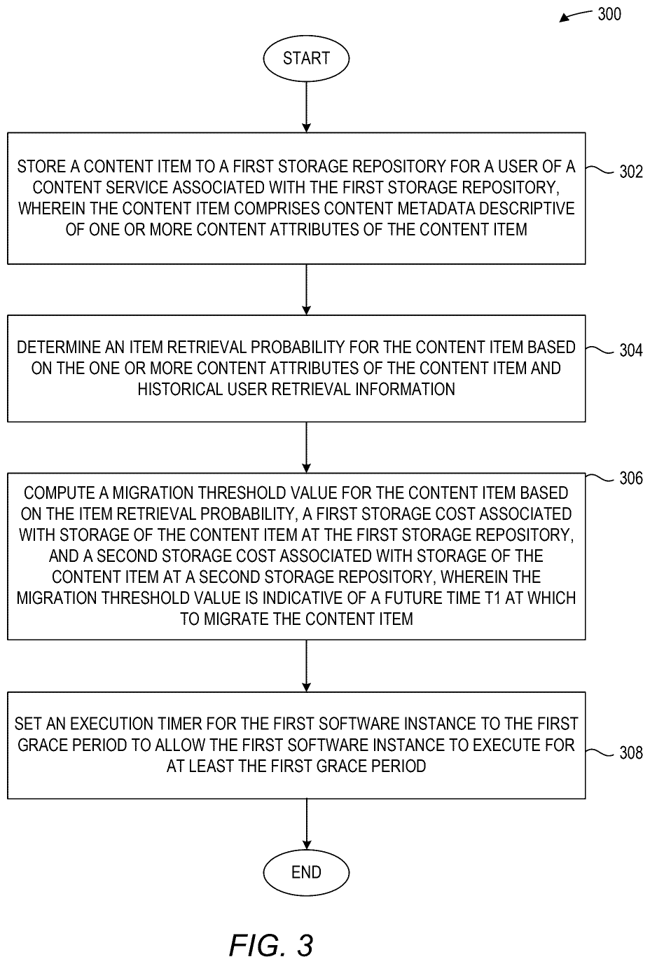

FIG. 3 depicts a flow chart diagram of an example method 300 for long-term cloud archival optimization for streaming media content according to some implementations of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, the computing system can store a content item to a first storage repository for a user of a content service associated with the first storage repository. The content item can include content metadata descriptive of one or more content attributes of the content item.

At 304, the computing system can determine an item retrieval probability for the content item based on the one or more content attributes of the content item and historical user retrieval information.

At 306, the computing system can compute a migration threshold value for the content item based on the item retrieval probability, a first storage cost associated with storage of the content item at the first storage repository, and a second storage cost associated with storage of the content item at a second storage repository. The migration threshold value is indicative of a future time T1 at which to migrate the content item.

At 308, responsive to occurrence of the future time T1, the computing system can migrate at least a portion of the content item from the first storage repository to the second storage repository.

In some implementations, the computing system can receive a request from a computing device associated with the user of the content service to retrieve the first content item. In some implementations, the computing system can retrieve the at least the portion of the content item from the second storage repository. The computing system can transmit the content item to the computing device associated with the user of the content service.

In some implementations, the computing system can migrate a second portion of the content item from the first storage repository to the second storage repository. A first portion of the content item can remain in the first storage repository. In such instances, the first portion of the content item can be located closer to the “beginning” of the content item (e.g., with regards to playback) than the second portion. The computing system 12 can retrieve the second portion of the content item from the second storage repository.

In some implementations, to transmit the content item, the computing system can, while retrieving the second portion of the content item from the second storage repository, transmit the first portion of the content item to the computing device associated with the user of the content service.

In some implementations, the one or more content attributes can include a content type attribute indicative of a first content type of a plurality of content types. The content types can include a VR/AR content type, an audiovisual content type, a video game content type, a video-on-demand content type, or a cDVR content type.

In some implementations, the historical user retrieval information includes a plurality of decay functions respectively associated with the plurality of content types. Each of the plurality of decay functions can represent a probability over time that a user will retrieve a particular content item of an associated content type of the plurality of content types.

In some implementations, to determine the item retrieval probability for the content item, the computing system can select a first decay function from the plurality of decay functions. The first decay function is associated with the first content type of the plurality of content types, and the item retrieval probability can be the first decay function. In some implementations, the decay function can be a nonlinear decay function, and a second decay function of the plurality of decay functions can be a linear decay function.

In some implementations, the one or more content attributes include a second content attribute (e.g., a playback length of the content item, a genre associated with the content item, aggregated user feedback related to the content item, a current playback statistic for the content item, etc. In some implementations, the computing system can adjust the first decay function based on the second content attribute.

In some implementations, to compute the migration threshold value, the computing system can determine an expected migration cost based on the item retrieval probability and the second storage cost associated with storage of the content item at the second storage repository. The computing system can determine that at the future time T1, the expected migration cost is less than the first storage cost. The computing system can add the item retrieval probability to the second storage cost and a processing cost associated with processing operations necessary to retrieve the content item from the second storage repository.

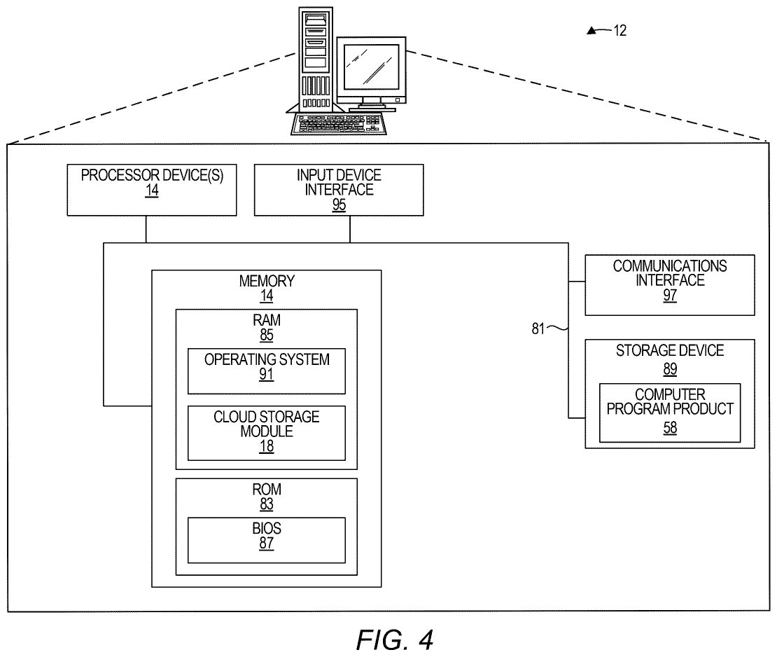

FIG. 4 is a block diagram of the computing system 12 suitable for implementing examples according to one example. The computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The computing system 12 includes the processor device(s) 14, the memory 16, and a system bus 81. The system bus 81 provides an interface for system components including, but not limited to, the memory 16 and the processor device(s) 14. The processor device(s) 14 can be any commercially available or proprietary processor.

The system bus 81 may be any of several types of bus structures that may further interconnect to a memory bus (with or without a memory controller), a peripheral bus, and/or a local bus using any of a variety of commercially available bus architectures. The memory 16 may include non-volatile memory 83 (e.g., read-only memory (ROM), erasable programmable read-only memory (EPROM), electrically erasable programmable read-only memory (EEPROM), etc.), and volatile memory 85 (e.g., random-access memory (RAM)). A basic input/output system (BIOS) 87 may be stored in the non-volatile memory 83 and can include the basic routines that help to transfer information between elements within the computing system 12. The volatile memory 85 may also include a high-speed RAM, such as static RAM, for caching data.

The computing system 12 may further include or be coupled to a non-transitory computer-readable storage medium such as the storage device 89, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 89 and other drives associated with computer-readable media and computer-usable media may provide non-volatile storage of data, data structures, computer-executable instructions, and the like.

A number of modules can be stored in the storage device 89 and in the volatile memory 85, including an operating system 91 and one or more program modules, such as the cloud storage module 18, which may implement the functionality described herein in whole or in part. All or a portion of the examples may be implemented as a computer program product 93 stored on a transitory or non-transitory computer-usable or computer-readable storage medium, such as the storage device 89, which includes complex programming instructions, such as complex computer-readable program code, to cause the processor device(s) 14 to carry out the steps described herein. Thus, the computer-readable program code can comprise software instructions for implementing the functionality of the examples described herein when executed on the processor device(s) 14. The processor device(s) 14, in conjunction with the cloud storage module 18 in the volatile memory 85, may serve as a controller, or control system, for the computing system 12 that is to implement the functionality described herein.

Because the cloud storage module 18 is a component of the computing system 12, functionality implemented by the cloud storage module 18 may be attributed to the computing system 12 generally. Moreover, in examples where the cloud storage module 18 comprises software instructions that program the processor device(s) 14 to carry out functionality discussed herein, functionality implemented by the cloud storage module 18 may be attributed herein to the processor device(s) 14.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 14 through an input device interface 95 that is coupled to the system bus 81 but can be connected by other interfaces such as a parallel port, an Institute of Electrical and Electronic Engineers (IEEE) 1394 serial port, a Universal Serial Bus (USB) port, an IR interface, and the like. The computing system 12 may also include the communications interface 97 suitable for communicating with the network as appropriate or desired. The computing system 12 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

1. A method comprising:
storing, by a computing system comprising one or more processor devices, a content item to a first storage repository for a user of a content service associated with the first storage repository, wherein the content item comprises content metadata descriptive of one or more content attributes of the content item;
determining, by the computing system, an item retrieval probability for the content item based on the one or more content attributes of the content item and historical user retrieval information;
computing, by the computing system, a migration threshold value for the content item based on the item retrieval probability, a first storage cost associated with storage of the content item at the first storage repository, and a second storage cost associated with storage of the content item at a second storage repository, wherein the migration threshold value is indicative of a future time T1 at which to migrate the content item, and wherein computing the migration threshold value comprises:
determining, by the computing system, that at the future time T1, an expected migration cost is less than the first storage cost; and
responsive to occurrence of the future time T1, migrating, by the computing system, at least a portion of the content item from the first storage repository to the second storage repository.

2. The method of claim 1, wherein the method further comprises:
receiving, by the computing system, a request from a computing device associated with the user of the content service to retrieve the content item.

3. The method of claim 2, wherein the method further comprises:
retrieving, by the computing system, the at least the portion of the content item from the second storage repository; and
transmitting, by the computing system, the content item to the computing device associated with the user of the content service.

4. The method of claim 3, wherein migrating the at least the portion of the content item from the first storage repository to the second storage repository comprises:
migrating a second portion of the content item from the first storage repository to the second storage repository, wherein a first portion of the content item remains in the first storage repository; and
wherein retrieving the at least the portion of the content item from the second storage repository comprises:
retrieving, by the computing system, the second portion of the content item from the second storage repository.

5. The method of claim 4, wherein transmitting the content item to the computing device associated with the user of the content service comprises:
while retrieving the second portion of the content item from the second storage repository, transmitting, by the computing system, the first portion of the content item to the computing device associated with the user of the content service.

6. The method of claim 1, wherein the one or more content attributes comprises a content type attribute indicative of a first content type of a plurality of content types, comprising:
a Virtual Reality (VR)/Augmented Reality (AR) content type;
an audiovisual content type;
a video game content type;
a video-on-demand content type; or
a cloud digital video recording (cDVR) content type.

7. The method of claim 6, wherein the historical user retrieval information comprises a plurality of decay functions respectively associated with the plurality of content types, wherein each of the plurality of decay functions represents a probability over time that a user will retrieve a particular content item of an associated content type of the plurality of content types.

8. The method of claim 7, wherein determining the item retrieval probability for the content item based on the one or more content attributes of the content item and the historical user retrieval information comprises:
selecting, by the computing system, a first decay function from the plurality of decay functions, wherein the first decay function is associated with the first content type of the plurality of content types, and wherein the item retrieval probability comprises the first decay function.

9. The method of claim 8, wherein the first decay function comprises a nonlinear decay function, and wherein a second decay function of the plurality of decay functions comprises a linear decay function or a nonlinear decay function.

10. The method of claim 8, wherein the one or more content attributes comprise a second content attribute, and wherein the second content attribute comprises one or more of:
a playback length of the content item;
a genre associated with the content item;
a seasonality of the content item;
aggregated user feedback related to the content item;
current playback statistics for the content item;
historical playback statistics for a plurality of user demographic classifications.

11. The method of claim 10, wherein the second content attribute comprises the genre associated with the content item, wherein the historical user retrieval information is descriptive of a user demographic classification associated with the user of the content service, wherein the user demographic classification is associated with a preference for a particular genre; and
wherein determining the item retrieval probability for the content item based on the one or more content attributes of the content item and the historical user retrieval information comprises:
determining, by the computing system, the item retrieval probability based on a similarity between the particular genre and the genre associated with the content item.

12. The method of claim 10, wherein selecting the first decay function from the plurality of decay functions further comprises:
adjusting, by the computing system, the first decay function based on the second content attribute.

13. The method of claim 1, wherein computing the migration threshold value for the content item comprises:
determining, by the computing system, the expected migration cost based on one or more of:
the item retrieval probability;
the second storage cost associated with storage of the content item at the second storage repository; or
costs associated with retrieval of the content item from the second storage repository.

14. The method of claim 13, wherein determining the expected migration cost further comprises:
multiplying, by the computing system, the item retrieval probability by the costs associated with retrieval of the content item from the second storage repository.

15. A computing system comprising:
a memory;
one or more processor devices configured to:
store a content item to a first storage repository for a user of a content service associated with the first storage repository, wherein the content item comprises content metadata descriptive of one or more content attributes of the content item;
determine an item retrieval probability for the content item based on the one or more content attributes of the content item and historical user retrieval information;
compute a migration threshold value for the content item based on the item retrieval probability, a first storage cost associated with storage of the content item at the first storage repository, and a second storage cost associated with storage of the content item at a second storage repository, wherein the migration threshold value is indicative of a future time T1 at which to migrate the content item, and wherein, to compute the migration threshold value, the one or more processor devices are configured to:
determine, that at the future time T1, an expected migration cost is less than the first storage cost; and
responsive to occurrence of the future time T1, migrate at least a portion of the content item from the first storage repository to the second storage repository.

16. The computing system of claim 15, wherein the one or more processor devices are further to:
receive a request from a computing device associated with the user of the content service to retrieve the content item.

17. The computing system of claim 16, wherein the one or more processor devices are further to:
retrieve the at least the portion of the content item from the second storage repository; and
transmit the content item to the computing device associated with the user of the content service.

18. The computing system of claim 17, wherein, to migrate the at least the portion of the content item from the first storage repository to the second storage repository, the one or more processor devices are to:
migrate a second portion of the content item from the first storage repository to the second storage repository, wherein a first portion of the content item remains in the first storage repository; and
wherein, to retrieve the at least the portion of the content item from the second storage repository, the one or more processor devices are to:
retrieve the second portion of the content item from the second storage repository.

19. The computing system of claim 18, wherein, to transmit the content item to the computing device associated with the user of the content service, the one or more processor devices are to:
while retrieving the second portion of the content item from the second storage repository, transmit the first portion of the content item to the computing device associated with the user of the content service.

20. A non-transitory computer-readable storage medium that includes executable instructions to cause one or more processor devices to:
store a content item to a first storage repository for a user of a content service associated with the first storage repository, wherein the content item comprises content metadata descriptive of one or more content attributes of the content item;
determine an item retrieval probability for the content item based on the one or more content attributes of the content item and historical user retrieval information;
compute a migration threshold value for the content item based on the item retrieval probability, a first storage cost associated with storage of the content item at the first storage repository, and a second storage cost associated with storage of the content item at a second storage repository, wherein the migration threshold value is indicative of a future time T1 at which to migrate the content item, and wherein, to compute the migration threshold value, the one or more processor devices are to:
determine, that at the future time T1, an expected migration cost is less than the first storage cost; and
responsive to occurrence of the future time T1, migrate at least a portion of the content item from the first storage repository to the second storage repository.
